(19) United States
(12) Patent Application Publication
(10) Pub. No.: US 2026/0202357 A1
(43) Pub. Date: Jul. 16, 2026

(54) X-RAY SOURCE FOR AN X-RAY IMAGING SYSTEM, X-RAY IMAGING SYSTEM AND METHOD FOR OPERATING AN X-RAY IMAGING SYSTEM

(71) Applicant: Carl Zeiss SMT GmbH, Oberkochen (DE)

(72) Inventor: Thomas Anthony CASE, Walnut Creek, CA (US)

(21) Appl. No.: 19/015,801

(22) Filed: Jan. 10, 2025

(51) Int. Cl. G01N 23/04; H01J 35/14

(52) U.S. Cl. CPC G01N 23/04; H01J 35/14; G01N 2223/1016; G01N 2223/204; H01J 2235/1216

(57) ABSTRACT

An x-ray source for an x-ray imaging system, comprises: a vacuum chamber; an electron source accommodated in the chamber for emitting an electron beam; and an x-ray target accommodated in the chamber for generating x-rays when irradiated with the electron beam. The x-ray source comprises, with respect to an outer shape thereof, a protruding portion protruding from a remaining portion of the x-ray source. The protruding portion includes at its distal end the x-ray target.

### INCORPORATION BY REFERENCE

This application incorporates by reference the following commonly owned applications filed on even date herewith:
U.S. Ser. No.______(Attorney Docket: 36066-0080001), entitled “X-Ray Source for an X-Ray Imaging System and X-Ray Imaging System”;
U.S. Ser. No.______(Attorney Docket: 36066-0081001), entitled “X-Ray Imaging System and Method for Operating an X-Ray Imaging System”;
U.S. Ser. No.______(Attorney Docket: 36066-0082001), entitled “Sample Mount Assembly for An X-Ray Imaging System and X-Ray Imaging System”;
U.S. Ser. No.______(Attorney Docket: 36066-0084001), entitled “X-Ray Detector Assembly, X-Ray Imaging System and Method for Manufacturing an X-Ray Detector Assembly”; and
U.S. Ser. No.______(Attorney Docket: 36066-0085001), entitled “X-Ray Imaging System”.

### FIELD

The present disclosure relates to an x-ray source for an x-ray imaging system, an x-ray imaging system with such an x-ray source and a method for operating such an x-ray imaging system.

### BACKGROUND

X-rays are widely used in microscopy at least in part because of their short wavelengths and ability to penetrate objects. Three-dimensional (3D) x-ray imaging techniques can be useful to image internal structures of objects. Typically, based on a dataset including x-ray transmission images of a sample that are collected over a large angular range, 3D images are reconstructed. An x-ray imaging system usually comprises a sample mount to support a sample, an x-ray source configured to illuminate a region of interest of the sample, and a position-sensitive x-ray detector configured to record x-rays transmitted through the region of interest of the sample.

The x-ray flux incident on the region of interest of the sample is, in general, inversely proportional to the square of the distance of the region of interest from the x-ray source. Decreasing this distance can increase throughput for x-ray imaging. In other words, it can be desirable to place the region of interest of the sample as close to the x-ray source as is reasonably possible such that the x-ray flux density at the region of interest is as high as is reasonably possible. A high x-ray flux density at the region of interest of the sample can imply relatively short exposures times and, hence, a relatively high throughput of a series of samples imaged with the x-ray imaging system.

### SUMMARY

The present disclosure seeks to provide an improved x-ray source for an x-ray imaging system, an improved x-ray imaging system and an improved method for operating an x-ray imaging system.

According to a first aspect, the disclosure provides an x-ray source for an x-ray imaging system. The x-ray source comprises: a vacuum chamber; an electron source accommodated in the chamber for emitting an electron beam; and an x-ray target accommodated in the chamber for generating x-rays when irradiated with the electron beam. The x-ray source comprises, with respect to an outer shape thereof, a protruding portion protruding from a remaining portion of the x-ray source. The protruding portion includes at its distal end the x-ray target.

Having the protruding portion with the x-ray target protruding from the remaining portion of the x-ray source can help allow for arranging the x-ray target of the x-ray source close to a region of interest of a sample which is imaged with the x-ray imaging system. For example, the x-ray target of the x-ray source can be arranged at a distance to the region of interest of the sample of 0.5 millimeter (mm) or less (e.g., 0.4 mm or less, 0.3 mm or less, 0.2 mm or less, 0.1 mm or less, 0.05 mm or less). Even a physical contact of the x-ray target with the region of interest of the sample (zero distance between the x-ray target and the region of interest) is possible. For example, with the proposed configuration of the x-ray source, the distance between the x-ray target and the sample is not limited by the outer geometry of the remaining portion (e.g., a magnetic focus lens). Hence, the region of interest of the sample can be arranged very close to the x-ray source. Since the x-ray flux incident on the region of interest is in general inversely proportional to the square of the distance of the region of interest from the x-ray target, with the proposed configuration a high x-ray flux density at the region of interest of the sample is achieved. A relatively high x-ray flux density at the region of interest can imply relatively short exposures times and, therefore, a series of samples can be analyzed relatively quickly with the x-ray imaging system resulting in a relatively high throughput rate.

The samples analyzed with the proposed x-ray imaging system are, for example, flat extended objects, such as wafers. In cases in which the samples deviate slightly from a flat geometry and are, instead, curved away from the x-ray source (e.g. by a few micrometers), it might be difficult to achieve a small source-sample-distance. Such curved samples may, for example, arise from the energy input when printing different layers (e.g., 50 to 100 layers) of semiconductor circuits onto a wafer as a sample. However, with the proposed x-ray source having the protruding portion holding the x-ray target, a small source-sample-distance is still possible in a case in which the sample is slightly curved away from the x-ray source.

The x-ray imaging system is configured for imaging a region of interest of a sample. The sample is, for example, a flat extended object. The sample is, for example, a wafer. The wafer includes, for example, electronic and/or semiconductor components. Just as an example, the x-ray imaging system may be used to inspect the wafer to investigate the quality of packaging of electronic components of the wafer. For example, the quality of mechanical and electrical bonding (e.g., buried interconnections) of the electronic components may be controlled. However, the sample may also be another object than a wafer. The sample is, for example, a circuit board or a battery.

The x-ray imaging system is, for example, a transmission x-ray imaging system, wherein the x-rays impacting on the region of interest of the sample are partly transmitting through the region of interest and are partly absorbed by the region of interest. The position-dependent transmitted portion of the x-rays can be detected by the position-sensitive x-ray detector as a two-dimensional x-ray image.

The x-ray imaging system is, for example, a three-dimensional imaging system. The x-ray imaging system is, for example, configured to obtain two-dimensional transmission images of the region of interest for different rotation angles of the sample. Based on the two-dimensional transmission images, a three-dimensional image of the region of interest can be reconstructed to reveal interior structures of the region of interest. The x-ray imaging system is, for example, an x-ray three-dimensional imaging system obtaining three-dimensional images by x-ray laminography and/or x-ray tomography.

The x-ray source is, for example, a transmission target type x-ray source. The electron beam can strike the at least one x-ray target of the x-ray source at its backside and the at least one x-ray target can emit x-rays at its front side, wherein the emitted x-rays can be used to irradiate the sample.

The x-ray source can generate diverging x-rays, i.e. a cone (conus) of x-rays. A portion (i.e. a sub cone) of the generated diverging x-rays can irradiate the region of interest of the sample. A center line of this sub cone of x-rays is referred herein as x-ray propagation axis. That means the x-ray propagation axis indicates the direction of an x-ray beam which is a portion of the total generated diverging x-rays of the x-ray source.

The x-ray source can comprise a vacuum chamber. The x-ray source comprises, for example, a pump for evacuating the vacuum chamber (or optionally the vacuum chamber and a fluidly connected flight tube).

The electron source includes, for example, a cathode and an anode and the like for generating electrons and for accelerating the generated electrons.

The electron beam may include a line profile which can, for example, hit the x-ray target at least partly.

The x-ray target is configured for emitting x-rays when bombard with the focused electron beam. A material of the at least one x-ray target comprises, for example, one or more of a group including tungsten (W), copper (Cu), chromium (Cr), molybdenum (Mo), rhodium (Rh) and platinum (Pt). The x-rays generated by the at least one x-ray target can include characteristic lines determined by the target's composition and broad bremsstrahlung radiation.

The x-ray source includes, for example, a carrier element carrying the x-ray target (or carrying multiple of the x-ray targets which can be selected by directing the electron beam accordingly). The carrier element is, for example, x-ray transmissive. The carrier element forms, for example, a vacuum window of the flight tube. Alternatively, an additional vacuum window may be provided. A material of the carrier element and/or the vacuum window includes, for example, atomic elements having atomic numbers less than 14. The material of the carrier element and/or the vacuum window includes, for example, one or more of a group including beryllium, diamond, boron carbide, silicon carbide, aluminum, and beryllium oxide. The material of the carrier element and/or the vacuum window can be diamond.

The carrier element and/or the vacuum window being x-ray transmissive means, for example, that it has an x-ray transmission such that more than 50% of the x-rays generated by the at least one x-ray target having energies greater than one-half of the selected maximum focused electron energy are transmitted through the carrier element.

The carrier element has, for example, a sufficiently high thermal conductivity to provide a thermal conduit to prevent thermal damage (e.g., melting) of the at least one x-ray target.

The carrier element can, for example, also provide an electrically conductive path to dissipate electric charge from the at least one x-ray target and/or the carrier element itself.

According to some embodiments, the x-ray source comprises: a flight tube fluidly connected at its proximal end to the vacuum chamber for providing a vacuum atmosphere inside the chamber and the tube; and a magnetic focus lens arranged around the flight tube for focusing the electron beam, wherein the electron source is configured for emitting the electron beam into the flight tube, the x-ray target is arranged at the distal end of the flight tube, and the distal end of the flight tube is protruding from an outer wall of the magnetic focus lens.

Having the distal end of the flight tube with the x-ray target protruding from the outer wall of the magnetic focus lens can help allow for an arrangement of the x-ray target close to the region of interest of the sample. For example, with the proposed configuration of the x-ray source, the distance between the x-ray target and the sample is not limited by the outer geometry of the magnetic focus lens.

For example, the flight tube comprises at its distal end the protruding portion protruding from the outer wall of the magnetic focus lens.

The vacuum chamber and the flight tube being fluidly connected means, for example, that an interior space of the vacuum chamber and an interior space of the flight tube are continuous with each other and/or that the vacuum of the vacuum chamber extends into the flight tube.

The flight tube can be configured for guiding the electron beam emitted from the electron source to the x-ray target. The flight tube has, for example, a cylindrical outer shape with a circular footprint. However, the flight tube can, for example, also have a cylindrical outer shape with a footprint different from a circular footprint (e.g., having a squared, rectangular or polygonal footprint). The flight tube is, for example, made from a material including copper.

The magnetic focus lens can be configured for focusing the electron beam before the electron beam hits the x-ray target. The magnetic focus lens comprises, for example, a yoke, a coil wound around the yoke and a yoke cap. The outer wall of the magnetic focus lens has, for example, a ring shape with a central opening through which the distal end of the flight tube protrudes. The outer wall of the magnetic focus lens is, for example, a portion of an outer wall of the magnetic focus lens. The outer wall of the magnetic focus lens is, for example, a portion of an outer wall of the yoke cap.

According to some embodiments, a length of the protruding portion is 200 micrometers (μm) or less, from 100μm to 200μm, from 200μm to 1 mm, and/or from 1 mm to 20 mm.

According to some embodiments, the x-ray source comprises a cooling arrangement for cooling the protruding portion and/or the flight tube including its distal end.

Having the cooling arrangement can help allow for cooling the protruding portion and/or the distal end of the flight tube with the x-ray target even though it is protruding from the remaining portion of the x-ray source and/or the outer wall of the magnetic lens.

For example, a carrier element carrying the x-ray target is configured to dissipate heat from the x-ray target, the carrier element is mechanically connected to the flight tube, and the cooling arrangement of the flight tube is configured to cool the carrier element. Thus, heat generated in the x-ray target by the impacting electron beam can be transmitted to the carrier element and dissipated to the flight tube.

According to some embodiments, the flight tube comprises at least three concentric walls forming at least two concentric ring-shaped conduits between them, the at least two concentric ring-shaped conduits are configured for guiding a coolant through a first one of the at least two conduits from the proximal end to the distal end of the flight tube and for guiding the coolant through a second one of the at least two conduits from the distal end to the proximal end of the flight tube.

The flight tube can be cooled at its entire lateral area.

The coolant includes, for example, water or another suitable cooling liquid.

According to some embodiments, the x-ray source comprises one or more electron optics units arranged around the flight tube for deflecting and/or shaping the electron beam emitted from the electron source before the magnetic focus lens is focusing the electron beam.

The one or more electron optics units are, for example, configured to direct, deflect and/or shape the electron beam. The electron optics include, for example, one or more magnetic lenses for focusing the electron beam and/or one or more deflection units for deflecting the electron beam.

The one or more electron optics units can be arranged with respect to a direction of the electron beam (i.e. with respect to a direction pointing from the proximal end to the distal end of the flight tube) such that the electron beam is deflected and/or shaped by the one or more electron optics units before it is focused by the magnetic focus lens.

According to some embodiments, the outer wall of the magnetic focus lens from which the distal end of the flight tube with the x-ray target protrudes, has a flat surface portion.

According to some embodiments, the outer wall of the magnetic focus lens from which the distal end of the flight tube with the x-ray target protrudes, has a convex surface portion curved in a direction pointing from the proximal end to the distal end of the flight tube, and the convex surface portion comprises a central opening through which the flight tube protrudes.

According to some embodiments, the x-ray source is configured for irradiating a sample with x-rays, and the x-ray source comprises a sensor unit for detecting a distance between the x-ray target and the sample.

Thus, when arranging the x-ray source very close to the sample, a distance between the x-ray source and the sample can be monitored. For example, the distance between the x-ray source and the sample can be controlled to be at a predetermined desired distance (e.g., at a distance ensuring a desired x-ray flux density at the region of interest of the sample and/or at a distance being not smaller than a predetermined minimum distance).

The sensor unit comprises, for example, one or more sensors arranged on the outer wall of the magnetic focus lens of the x-ray source. The sensor unit comprises, for example, three or more sensors arranged on a circle on the outer wall of the magnetic focus lens.

According to some embodiments, the sensor unit comprises one or more distance sensors, one or more capacitive sensors, one or more inductive sensors, one or more optical sensors, one or more interferometers, and/or one or more cameras.

According to an aspect, the disclosure provides an x-ray imaging system for imaging a region of interest of a sample. The x-ray imaging system comprises an x-ray source as described above.

According to some embodiments, the x-ray imaging system comprises a sample mount for supporting the sample. The sample mount can comprise an opening such that an x-ray beam emitted from the x-ray source to the region of interest of the sample passes through the opening of the sample mount.

Having the sample mount with the opening can help prevent the x-ray beam traveling to the x-ray detector from transmitting through the sample mount.

Having the sample mount with the opening means that the x-ray source (i.e. the x-ray target of the x-ray source) can be arranged even closer to the region of interest of the sample.

For example, in comparison with a sample without the opening, a distance between the x-ray target and the sample is at least the thickness of the sample mount (e.g., 2.5 mm). However, having the opening and the proposed x-ray source with the protruding distal end of the flight tube with the x-ray target means that the x-ray target can, for example, be arranged at a distance to the sample of 0.3 mm. Given that the x-ray flux incident on the region of interest of the sample is, in general, inversely proportional to the square of the distance of the region of interest from the x-ray source, the difference in x-ray power at the region of interest is a factor of about 70, because (2.5/0.3)² is equal to 69. In other words, by moving the x-ray target from a distance of 2.5 mm to a distance of 0.3 mm to the region of interest of the sample, a gain in x-ray power of about 70 is achieved.

The sample mount has, for example, a support surface for supporting the sample, the support surface defining an object plane of the x-ray imaging system.

The sample mount and/or a sample mount assembly including the sample mount is, for example, configured for supporting the sample rotatably around a rotation axis. In addition, the x-ray imaging system is, for example, configured for obtaining two-dimensional transmission images of the region of interest of the sample for different rotation angles of the sample with respect to the rotation axis. For example, the x-ray imaging system is configured for obtaining two-dimensional transmission images of the region of interest of the sample for different rotation angles of the sample with respect to the rotation axis, wherein the rotation angles span a large angular range of, for example, 180° or more (e.g., 270° or more, 360°). The x-ray imaging system is, for example, configured for reconstructing a three-dimensional image of the region of interest based on the two-dimensional transmission images. The x-ray imaging system comprises, for example, a control device for reconstructing the three-dimensional images.

According to some embodiments, the x-ray imaging system comprises: a drive unit for displacing the sample mount in a direction towards the x-ray source and away from the x-ray source; and/or a further drive unit for displacing the x-ray source in a direction towards the sample mount and away from the sample mount.

Having the drive unit and/or the further drive unit means that a distance between the x-ray target and the sample can be adjusted.

According to some embodiments, the x-ray imaging system comprises a feedback control device for performing a feedback control of a distance between the x-ray target and the sample.

Having the feedback control device means that a distance between the x-ray target and the sample can be controlled such that it is maintained in a closed control loop at a predetermined set distance. For example, a distance between the x-ray target and the sample can be maintained at a value corresponding to a desired x-ray flux density at the region of interest of the sample, and, hence, to a desired exposure time of the sample and desired throughput of the imaging system.

Using the closed control loop, undesired distance values can be avoided. For example, a physical contact of the x-ray target and the sample can be avoided.

According to some embodiments, the feedback control device is configured to: receive an actual value of a distance indicative for a distance between the x-ray target and the sample from a sensor unit; derive a further actual value of the distance between the x-ray target and the sample based on the received actual value; determine a deviation of the derived further actual value from a predetermined set value of the distance between the x-ray target and the sample; determine a control value based on the determined deviation; and generate a control signal for controlling a drive unit of the sample mount and/or of the x-ray source based on the determined control value.

The respective unit described above and/or below, e.g., the control device, the feedback control device, the feedback control unit, and the deviation determining unit, can be implemented in hardware or in software. When implemented in hardware, the respective unit can be configured as device and/or as part of a device, e.g., a computer or a microprocessor. When implemented in software, the respective unit can be configured as computer program product, as routine, as algorithm, as part of a program code and/or as executable object.

According to an aspect, the disclosure provides a method for operating an x-ray imaging system as described above. The method comprises: a) generating x-rays with an x-ray source of the x-ray imaging system such that the x-rays transmit through a region of interest of a sample; b) detecting an actual distance between the x-ray source and the sample; and c) performing a feedback control of the distance between the x-ray source and the sample based on the detected actual distance and a predetermined set distance between the x-ray source and the sample.

The embodiments and features described with reference to the x-ray source of the present disclosure apply mutatis mutandis to the x-ray imaging system and the method of the present disclosure.

Further possible implementations or alternative solutions of the disclosure also encompass combinations - that are not explicitly mentioned herein - of features described above or below with regard to the embodiments. The person skilled in the art may also add individual or isolated aspects and features to the most basic form of the disclosure.

Further embodiments, features and aspects of the present disclosure will become apparent from the subsequent description and dependent claims, taken in conjunction with the accompanying drawings, in which:

### BRIEF DESCRIPTION OF THE DRAWINGS

FIG. 1 shows a schematic view of an x-ray imaging system for imaging a sample;

FIG. 2 shows an x-ray source of the x-ray imaging system of FIG. 1;

FIG. 3 shows an x-ray source of the x-ray imaging system of FIG. 1;

FIG. 4 shows the x-ray source of FIG. 2 together with a sample mount, a sample, a detector and a feedback control device;

FIG. 5 shows a control loop for a feedback control of a distance between an x-ray target of the x-ray source and the sample of FIG. 4; and

FIG. 6 shows a flow chart illustrating a method for operating an x-ray imaging system.

### DETAILED DESCRIPTION

In the Figures, like reference numerals designate like or functionally equivalent elements, unless otherwise indicated.

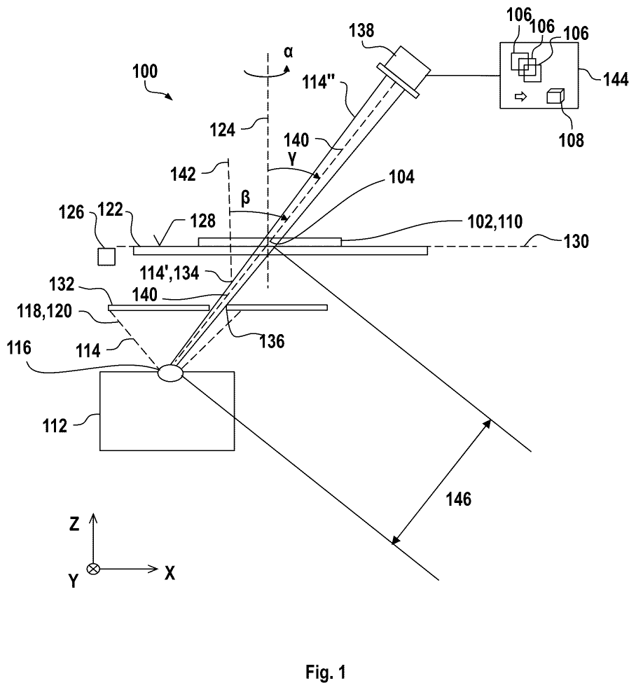

FIG. 1 shows a schematic view of an x-ray imaging system 100 according to an embodiment. The x-ray imaging system 100 is used for imaging a sample 102, for example a region of interest 104 of the sample 102. The x-ray imaging system 100 is configured to obtain two-dimensional transmission images 106 of the region of interest 104 for different rotation anglesα of the sample 102. Based on the two-dimensional transmission images 106, a three-dimensional (3D) image 108 of the region of interest 104 is reconstructed to reveal interior structures of the region of interest 104. The x-ray imaging system 100 is, hence, an x-ray 3D imaging system obtaining 3D images 108 by x-ray laminography and/or x-ray tomography.

The sample 102 is, for example, a flat object extended in a main plane (e.g., the xy-plane in FIG. 1). The sample 102 is, for example, a wafer 110 comprising electronic and/or semiconductor components. Just as an example, the x-ray imaging system 100 may be used to inspect the wafer 110 to investigate the quality of packaging of electronic components of the wafer 110. For example, the quality of mechanical and electrical bonding (e.g., buried interconnections) of the electronic components may be controlled.

The x-ray imaging system 100 comprises an x-ray source 112 for emitting x-rays 114. The x-rays 114 are emitted from a source region 116 of the x-ray source 112. The reference sign S denotes a spot size of the source region 116. The x-ray source 112 emits a diverging beam 118 of x-rays 114. In other words, the x-ray source 112 emits a cone 120 of x-rays 114. The sample 102 is arranged within the x-ray emission cone 120.

The x-ray imaging system 100 further comprises a sample mount 122 for supporting the sample 102 rotatably around a rotation axis 124. The rotation axis 124 passes, for example, through the region of interest 104 of the sample 102. For example, the rotation axis 124 can be arranged off-center with respect to a center of the sample 102. A rotation drive 126 for rotating the sample mount 122 and, hence, the sample 102, is shown schematically in FIG. 1. Furthermore, the sample mount 122 has a support surface 128 for supporting the sample 102, wherein the support surface 128 defines an object plane 130 of the x-ray imaging system 100.

The x-ray imaging system 100 may further comprise, for example, a shield stop 132 arranged between the x-ray source 112 and the sample mount 122. The shield stop 132 is, for example, arranged in a light path of the x-rays 114 emitted from the x-ray source 112. The shield stop 132 serves to select a usable portion 134 (sub cone 134) of the x-ray cone 120. Moreover, the shield stop 132 protects uninspected regions of the sample 102 from x-ray exposure. The shield stop 132 has an aperture 136 through which the usable portion 134 of the x-ray light 114 (114′) propagates in the direction of the region of interest 104 of the sample 102 and transmits through the region of interest 104 of the sample 102.

The x-ray imaging system 100 further comprises a position-sensitive x-ray detector 138 for detecting x-rays 114″ transmitted through the region of interest 104 of the sample 102. The position-sensitive x-ray detector 138 is, for example, configured to convert the incoming x-rays 114″ into light of longer wavelength, e.g., UV-light, visible light or infrared light. The x-ray detector 138 includes, for example, a scintillator material at a transfer field of the detector 138 for converting the x-rays 114″ into detectable light and a detector array 138 (e.g., a CCD or CMOS array) for detecting the detectable light.

FIG. 1 displays an x-ray propagation axis 140 of the x-ray imaging system 100. For example, a central axis of the portion 134 (sub light cone 134) of the x-ray light 114 passing through the shield stop 132 defines the x-ray propagation axis 140. The x-ray propagation axis 140 extends from the x-ray source 112 (i.e., the source region 116 of the x-ray source 112), through the region of interest 104 of the sample 102, and to the position-sensitive x-ray detector 138.

As can be seen in FIG. 1, the x-ray propagation axis 140 of the x-ray imaging system 100 is, for example, inclined with respect to a surface normal 142 of the sample mount 122 by a first angle β. In addition, the x-ray propagation axis 140 is, for example, inclined with respect to the rotation axis 124 by a second angle γ. In the example of FIG. 1, the surface normal 142 of the sample mount 122 and the rotation axis 124 are arranged parallel to each other and, hence, the first angle β and the second angle γ have the same size.

The x-ray exposures 106 obtained at different rotation angles α of the sample 102 are reconstructed to a 3D image 108 by a control system 144 of the imaging system 100.

The x-ray imaging system 100 provides microscopic imaging. A magnification and, hence, a spatial resolution, of the x-ray imaging system 100 depends on the size of the source region 116 of the x-ray source 112.

Moreover, an imaging time to obtain a 3D image 108 of the region of interest 104 of the sample 102 depends on the x-ray flux density Fₓ at the region of interest 104. The imaging time (exposure time) limits, for example, a throughput rate when imaging multiple samples 102 with the x-ray imaging system 100.

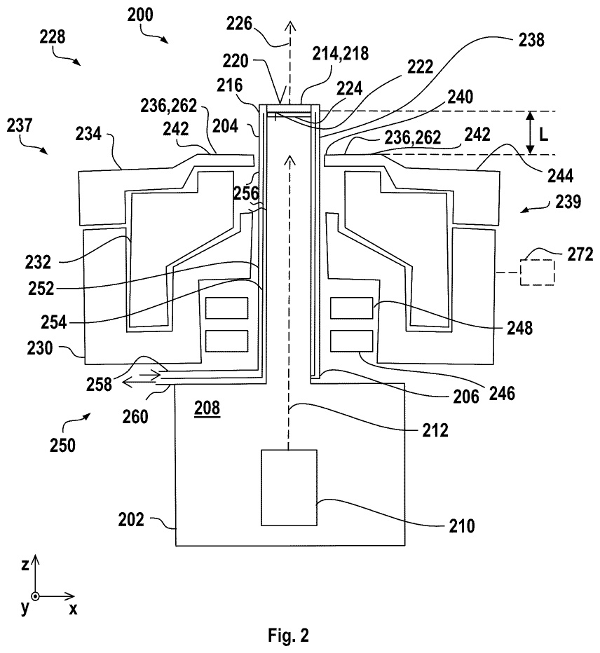

FIG. 2 shows an x-ray source 200 for the x-ray imaging system 100 of FIG. 1. The x-ray source 200 comprises a vacuum chamber 202. The x-ray source 200 further comprises, for example, a flight tube 204 fluidly connected at its proximal end 206 to the vacuum chamber 202. A vacuum atmosphere 208 is provided inside the vacuum chamber 202 and the flight tube 204.

The x-ray source 200 further incudes an electron source 210 accommodated in the vacuum chamber 202. The electron source 210 is configured for emitting an electron beam 212 towards an x-ray target 224 (e.g., towards the flight tube 204 such that the electron beam 212 flies through the flight tube 204 to the x-ray target 224).

The x-ray source 200 comprises in addition a carrier element 214 (e.g., made from diamond) arranged at a distal end 216 of the flight tube 204. The carrier element 214 is x-ray transmissive and forms a vacuum window 218 of the flight tube 204. The carrier element 214 comprises an outer surface 220 with respect to the flight tube 204 and an inner surface 222, arranged inside the vacuum atmosphere 208 of the flight tube 204. The carrier element 214 carries at its inner surface 222 an x-ray target 224 (e.g., made from tungsten).

The electron beam 212 (e.g., traveling through the flight tube 204) hits the x-ray target 224 and causes the x-ray target 224 to generate x-rays 226. The generated x-rays 226 are emitted from the x-ray source 200 through the vacuum window 218.

The x-ray source further comprises, for example, a magnetic focus lens 228 arranged around the flight tube 204. The magnetic focus lens 228 is, for example, arranged such that it surrounds the flight tube 204 from an outside along an entire circumference of the flight tube 204. The magnetic focus lens 228 is configured for focusing the electron beam 212 traveling through the flight tube 204. For example, the magnetic focus lens 228 generates a magnetic field at the location of the electron beam 212 that has a focusing effect on the electron beam 212.

The magnetic focus lens 228 comprises, for example, a yoke 230, a coil 232 wound around the yoke 230 and a yoke cap 234.

As can be seen in FIG. 2, the x-ray source 200 comprises, with respect to an outer (geometric) shape 237 thereof, a protruding portion 238 protruding from a remaining portion 239 of the x-ray source 200. Further, the protruding portion 238 includes at its distal end 216 the x-ray target 224.

In the example of FIG. 2, the distal end 216 of the flight tube 204 is protruding from an outer wall 236 of the magnetic focus lens 228. For example, the flight tube 204 comprises at its distal end 216 the protruding portion 238 protruding from the outer wall 236 of the magnetic focus lens 228. A length of the protruding portion 238 is denoted with the reference sign L in FIG. 2.

The outer wall 236 of the magnetic focus lens 228 has, for example, a ring shape with a central opening 240 through which the distal end 216 of the flight tube 204 protrudes.

The outer wall 236 of the magnetic focus lens 228 from which the distal end 216 of the flight tube protrudes is, for example, a portion 242 of an outer wall 244 of the yoke cap 234 of the magnetic focus lens 228.

The x-ray source 200 comprises further one or more electron optics units 246, 248 arranged around the flight tube 204. The one or more electron optics units 246, 248 are configured for deflecting and/or shaping the electron beam 212 emitted from the electron source 210. The electron beam 212 emitted from the electron source 210 enters, for example, the flight tube 204 at the proximal end 206 of the flight tube 204. Then, in a lower portion of the flight tube 204 adjacent the proximal end 206 of the flight tube 204, the electron beam 212 is shaped (e.g., focused) and deflected via a magnetic, electric and/or electromagnetic field generated by the one or more electron optics units 246, 248. For example, the electron beam 212 is directed via the one or more electron optics units 246, 248 towards the x-ray target 224 or towards a specific one of several x-ray targets 224 carried by the carrier element 214. Subsequently, the electron beam 212 is focused by the magnetic focus lens 228 before the electron beam 212 hits the x-ray target 224.

As illustrated in FIG. 2, the x-ray source 200 may comprise a cooling arrangement 250 for cooling the flight tube 204 including its distal end 216. In the example of FIG. 2, the cooling arrangement 250 comprises concentric ring-shaped conduits 252, 254 arranged at a wall of the flight tube 204. The concentric ring-shaped conduits 252, 254 are configured for guiding a coolant, e.g., water, through them. For example, the flight tube 204 comprises at least three concentric walls 256 forming at least two concentric ring-shaped conduits 252, 254 between them. The cooling arrangement 250 further comprises a supply conduct 258 for supplying the coolant to a first one 252 of the concentric ring-shaped conduits 252, 254. The cooling arrangement 250 comprises in addition a discharge conduct 260 for discharging the coolant from a second one 254 of the concentric ring-shaped conduits 252, 254. The first and second ring-shaped conduits 252, 254 are, for example, fluidly connected with each (e.g., at the distal end 216 of the flight tube 204). Hence, the first and second ring-shaped conduits 252, 254 are, for example, configured for guiding a coolant through the first ring-shaped conduit 252 from the proximal end 206 to the distal end 216 of the flight tube 204 and for guiding the coolant through the second ring-shaped conduit 254 from the distal end 216 to the proximal end 205 of the flight tube 204.

Although not shown in the figures, the cooling arrangement 250 comprises, for example, further conduits, one or more pumps, a cooling unit, one or more valves and the like.

Having the cooling arrangement 250 the distal end 216 of the flight tube 204 with the x-ray target 224 can be cooled even though it is protruding from the outer wall 236 of the magnetic lens 228. Cooling of the x-ray target 224 is particularly important since a significant amount of heat is generated in the x-ray target 224 by the impacting electron beam 212.

In the example of FIG. 2, the carrier element 214 carrying the x-ray target 224 is configured to dissipate heat from the x-ray target 224. The carrier element 214 is mechanically connected to the flight tube 204 such that the concentric ring-shaped conduits 252, 254 can cool the carrier element 214. Thus, heat generated in the x-ray target 224 can be transmitted to the carrier element 214 and dissipated to the flight tube 204.

In the example of FIG. 2, the outer wall portion 236 of the magnetic focus lens 228 from which the protruding portion 238 of the flight tube 204 protrudes, has a flat surface

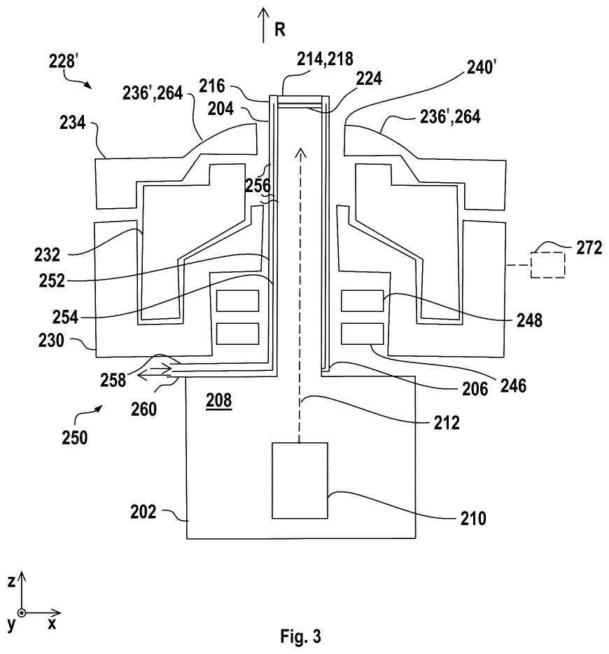

portion 262. However, as shown in FIG. 3, the outer wall portion 236′ of the magnetic focus lens 228′ from which the protruding portion 238 of the flight tube 204 protrudes, can also have a convex surface portion 264 curved in a direction R pointing from the proximal end 206 to the distal end 216 of the flight tube 204. The convex surface portion 264 comprises a central opening 240′ through which the flight tube 204 protrudes.

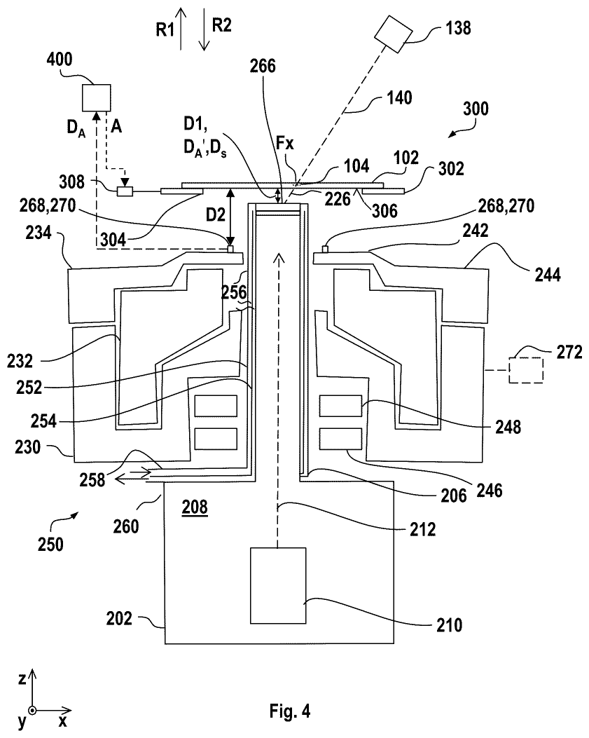

FIG. 4 shows the x-ray source 200 of FIG. 2 together with a sample mount assembly 300 for supporting a sample 102. The sample mount assembly 300 comprises a sample mount 302 configured similar as the sample mount 122 in FIG. 1 apart from that the sample mount 302 comprises an opening 304 such that an x-ray beam 226 emitted from the x-ray source 200 to a region of interest 104 of the sample 102 passes through the opening 304 of the sample mount 302. In other words, the x-ray beam 226 emitted from the x-ray source 200 to the region of interest 104 of the sample 102 does not transmit through material of the sample mount 302.

Having the x-ray source 200 with the protruding portion 238 with the x-ray target 224 and having the sample mount 302 with the opening 304 allows to arranged the x-ray target 224 very close to the region of interest 104 of the sample 102. With a very small distance D1 between the x-ray target 224 and the sample 102 (see also reference sign 146 in FIG. 1), a high of x-ray flux density Fₓ at the region of interest 104 of the sample 102 can be provided. Therefore, a series of samples 102 can be analyzed with the x-ray imaging system 100 with a high throughput.

The distance D1 between the x-ray target 224 and the sample 102 is, for example, a distance between a top surface 266 of the carrier element 214 carrying the x-ray target 224 and a bottom surface 306 of the sample 102.

The x-ray source 200 may comprise a sensor unit 268 for monitoring the distance D1 between the x-ray target 224 and the sample 102, as illustrated in FIG. 4. The sensor unit 268 comprises, for example, one or more distance sensors 270. The one or more distance sensors 270 are, for example, arranged on the ring-shaped outer wall 236 of the magnetic focus lens 228. In this case, the sensor unit 268 is configured for measuring a distance D2 between the outer wall 236 of the magnetic focus lens 228 and the sample 102 (e.g., the bottom surface 304 of the sample 102). A control device 400 of the x-ray imaging system may be configured for deriving the distance D1 from the measured distance D2.

The x-ray imaging system 100, e.g., the sample mount assembly 300, may comprise a drive unit 308 for displacing the sample mount 302 in a direction R1 towards the x-ray source 224 and a direction R2 away from the x-ray source 224. By using the drive unit 308 of the sample mount assembly 300, the distance D1 between the x-ray target 224 and the sample 102 can be set. The directions R, R1, and R2 are arranged parallel to a z-direction in the figures.

In addition or alternative to the drive unit 308 of the sample mount assembly 300, the x-ray imaging system 100, e.g., the x-ray source 200, may comprise a further drive unit 272 (FIG. 2) for displacing the x-ray source 200 in a direction R2 towards the sample mount 302 and a direction R1 away from the sample mount 302.

The x-ray imaging system 100 may include the control device 400. The control device 400 may, for example, be a feedback control device for performing a feedback control of the distance D1 between the x-ray target 224 and the sample 102. With such a feedback control, the distance D1 between the x-ray target 224 and the sample 102 can be monitored and maintained at a desired distance D_{S}.

The feedback control device 400 is, for example, configured to receive an actual value D_{A} of a distance D2 indicative for a distance D1 between the x-ray target 224 and the sample 102 from the sensor unit 268. The feedback control device 400 is further configured to derive a further actual value D_{A}′ of the distance D1 between the x-ray target 224 and the sample 102 based on the received actual value DA. Moreover, the feedback control device 400 is configured to determine a deviation e(t) of the derived further actual value D_{A}′ from a predetermined set value DS of the distance D1 between the x-ray target 224 and the sample 102. Then, the feedback control device 400 determines a control value u(t) based on the determined deviation e(t), and generates a control signal A for controlling a drive unit of the sample mount and/or of the x-ray source based on the determined control value.

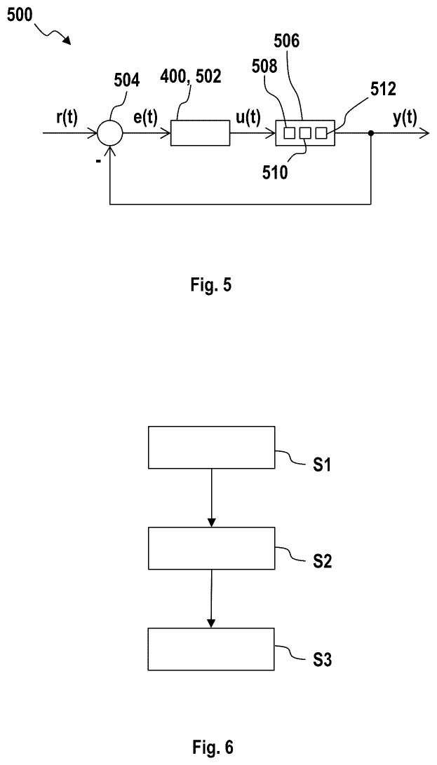

FIG. 5 shows a control loop 500 for performing a feedback control of the distance D1 between the x-ray target 224 and the sample 102. The control device 400 includes, for example, a control unit 402 for determining the control value u(t). The control device 400 includes further, for example, a deviation determining unit 402 for determining the deviation e(t).

The reference sign r(t) in FIG. 5 denotes a reference variable of the control loop 500. The reference variable r(t) corresponds to the set value D_{S} of the distance D1 between the target 224 and the sample 102. The reference variable r(t) may be a time-dependent parameter (time t) or may be a constant parameter. The reference sign y(t) denotes a (time-dependent) control variable of the control loop 500. The control variable y(t) corresponds to the further actual value D_{A}′ of the distance D1.

The deviation determining unit 504 is configured for determining the deviation e(t) of the control variable y(t) (i.e. the further actual value DA') from the reference variable r(t) (i.e. the set value D_{S}). Then, the feedback control unit 502 determines the control value u(t) based on the determined deviation e(t). For example, the feedback control unit 502 generates, based on the determined control value u(t), a control signal A (FIG. 4) for controlling the drive unit 308 of the sample mount assembly 300 and/or for controlling the further drive unit 272 (FIG. 2) of the x-ray source 200

The reference sign 506 in FIG. 5 denotes a control section of the control loop 500. The control section 506 includes a sensor unit 508 (sensor unit 268 in FIG. 4), for determining the actual value y(t) of the distance D1. The control section 506 includes an actuator unit 510 (e.g., the drive unit 308 in FIG. 4 and/or the further drive unit 272 in FIG. 2) for setting the distance D1. Furthermore, the reference sign 512 of the control section 506 of the control loop 500 indicates the system to be actuated, e.g., the x-ray source 200 and/or the sample mount assembly 300.

In the following, a method for operating an x-ray imaging system 100 (FIG. 1) is described with reference to FIG. 6.

In a first step S1 of the method, x-rays 226 are generated with an x-ray source 200 (FIG. 2) of the x-ray imaging system 100 such that the x-rays 226 transmit through a region of interest 104 of a sample 102 (FIG. 1). In a second step S2 of the method, an actual distance D1, D_{A}′ between the x-ray source 200 and the sample 102 is detected.

In a third step S3 of the method, a feedback control of the distance D1 between the x-ray source 200 and the sample 102 is performed based on the detected actual distance D_{A}′ and a predetermined set distance DS between the x-ray source 200 and the sample 102.

Although the present disclosure has been described in accordance with certain embodiments, it is obvious for the person skilled in the art that modifications are possible in all embodiments.

### REFERENCE NUMERALS

100 System
102 Sample
104 Region of interest
106 2D image
108 3D image
110 Wafer
112 Source
114 X-ray
114′, 114″ X-ray
116 Source region
118 Beam
120 Cone
122 Sample mount
124 Rotation axis
126 Rotation drive
128 Surface
130 Object plane
132 Shield stop
134 Portion
136 Aperture
138 Detector
140 Axis
142 Surface normal
144 Control system
146 Sign
200 Source
202 Vacuum chamber
204 Tube
206 End
208 Vacuum atmosphere
210 Source
212 Beam
214 Carrier element
216 End
218 Vacuum window
220 Outer surface
222 Inner surface
224 Target
226 X-ray
228, 228′Lens
230 Yoke
232 Coil
234 Yoke cap
236, 236′Outer wall
237 Shape
238 Portion
239 Portion
240, 240′Opening
242 Portion
244 Outer wall
246 Optic unit
248 Optic unit
250 Cooling arrangement
252 Conduit
254 Conduit
256 Wall
258 Conduct
260 Conduct
262 Surface portion
264 Surface portion
268 Sensor unit
270 Sensor
272 Unit
300 Sample mount assembly
302 Sample mount
304 Opening
306 Surface
308 Unit
400 Control device
500 Control loop
502 Control unit
504 Determining unit
506 Reference sign
508 Sensor unit
510 Actuator unit
512 System
α Angle
β Angle
γ Angle
A Signal
D_{A}, D_{A}′ Value
D_{S} Set value
D1, D2Distance
e(t) Deviation
Fx Flux Density
L Length
R Direction
R1, R2Direction
r(t) Reference variable
S1-S3 Step
u(t) Control Value
y(t) Reference sign
x,y,z Direction

What is claimed is:

1. An x-ray source, comprising:
a chamber;
an electron source in the chamber, the electron source configured to emit an electron beam; and
an x-ray target in the chamber, the x-ray target configured to generate x-rays when irradiated with the electron beam,
wherein:
the x-ray source comprises a first portion and a second portion different from the first portion;
the first portion protrudes from the second portion;
the first portion comprises a distal end; and
the x-ray target is at the distal end of the first portion.

2. The x-ray source of claim 1, further comprising:
a flight tube having a proximal end fluidly connected to the chamber, the flight tube and chamber configured to have a vacuum atmosphere therein; and
a magnetic focus lens around the flight tube, the magnetic lens configured to focus the electron beam,
wherein:
the electron source is configured to emit the electron beam into the flight tube;
the x-ray target is at a distal end of the flight tube; and
the distal end of the flight tube protrudes from an outer wall of the magnetic focus lens.

3. The x-ray source of claim 2, further comprising an arrangement configured to cool the first portion and/or the distal end of the flight tube.

4. The x-ray source of claim 2, wherein:
the flight tube comprises three concentric walls defining first and second concentric ring-shaped conduits between them;
the first concentric ring-shaped conduit is configured to guide a coolant from the proximal end of the flight tube to the distal end of the flight tube; and
the second concentric ring-shaped conduit is configured to guide the coolant from the distal end of the flight tube to the proximal end of the flight tube.

5. The x-ray source of claim 2, further comprising an electron optics unit around the flight tube, wherein the electron optics unit is configured to deflect and/or shape the electron beam emitted from the electron source before the electron beam is focused by the magnetic focus lens.

6. The x-ray source of claim 2, wherein the distal end of the flight tube has a flat surface portion.

7. The x-ray source of claim 2, wherein the outer wall has a convex surface portion curved in a direction pointing from the proximal end of the flight tube to the distal end of the flight tube, and the convex surface portion of the outer wall comprises a central opening through which the flight tube protrudes.

8. The x-ray source of claim 2, wherein the first portion has a length that is 200 micrometer (μm) or less, from 100 μm to 200 μm, from 200 μm to one millimeter (mm), and/or between 1 mm and 20 mm.

9. The x-ray source of claim 2, further comprising an arrangement configured to cool the first portion.

10. The x-ray source of claim 2, wherein:
the x-ray source is configured to irradiate a sample with x-rays; and
the x-ray source comprises a sensor unit configured to detect a distance between the x-ray target and the sample.

11. The x-ray source of claim 1, wherein the first portion has a length that is 200 micrometer (μm) or less, from 100 μm to 200 μm, from 200 μm to one millimeter (mm), and/or between 1 mm and 20 mm.

12. The x-ray source of claim 1, further comprising an arrangement configured to cool the first portion.

13. The x-ray source of claim 1, wherein:
the x-ray source is configured to irradiate a sample with x-rays; and the x-ray source comprises a sensor unit configured to detect a distance between the x-ray target and the sample.

14. The x-ray source of claim 13, wherein the sensor unit comprises a distance sensor, a capacitive sensor, an inductive sensor, an optical sensor, an interferometer, and/or a camera.

15. A system, comprising:
an x-ray source according to claim 1 configured to direct x-rays to a sample,
wherein the system is an x-ray imaging system.

16. The x-ray imaging system of claim 15, further comprising a mount to support the sample, wherein the mount comprises an opening configured so that, during use of the x-ray imaging system, an x-ray beam emitted from the x-ray source to a region of interest of the sample passes through the opening of the mount.

17. The x-ray imaging system of claim 15, further comprising:
a unit configured to displace the mount in a direction toward the x-ray source and away from the x-ray source; and/or
a unit configured to displace the x-ray source in a direction toward the mount and away from the mount.

18. The x-ray imaging system of claim 15, further comprising a control device configured to control a distance between the x-ray target and the sample.

19. The x-ray imaging system of claim 18, wherein the control device is configured to:
receive an actual value of a distance indicative of a distance between the x-ray target and the sample from a sensor unit;
derive a further actual value of the distance between the x-ray target and the sample based on the received actual value;
determine a deviation of the derived further actual value from a predetermined set value of the distance between the x-ray target and the sample;
determine a control value based on the determined deviation; and
generate a control signal to control a drive unit of the sample mount and/or of the x-ray source based on the determined control value.

20. A method, comprising:
a) providing an x-ray imaging system according to claim 15;
b) generating x-rays with the x-ray source of the x-ray imaging system so that the x-rays transmit through a region of interest of a sample;
c) detecting an actual distance between the x-ray source and the sample; and
d) controlling the distance between the x-ray source and the sample based on the detected actual distance and a predetermined set distance between the x-ray source and the sample.
